(19) United States
(12) Patent Application Publication
(10) Pub. No.: US 2004/0007025 A1
(43) Pub. Date: Jan. 15, 2004

(54) Production process for porous glass preform

(75) Inventors: Takakazu Gotoh, Tokyo (JP); Masahiro Horikoshi, Tokyo (JP)

Correspondence Address: DARBY & DARBY P.C., P. O. BOX 5257, NEW YORK, NY, 10150-5257, US

(73) Assignee: Fujikura Ltd.

(21) Appl. No.: 10/339,939

(22) Filed: Jan. 10, 2003

(30) Foreign Application Priority Data
Mar. 13, 2002 (JP) 2002-068997
Sep. 13, 2002 (JP) 2002-268787

(51) Int. Cl. C03B 37/018; C03B 37/07

(52) U.S. Cl. 65/384; 65/415

(57) ABSTRACT

A method for producing a porous preform comprising measuring the surface temperature distribution at the end of the core soot preform, and (1) maintaining the surface temperature Tc at the center point on the end of the core soot preform in the range of 500 to 1000° C., and preferably in the range of 600 to 950° C.; and maintaining the difference Tm−Tc between the maximum surface temperature Tm at the end of the core soot preform and the surface temperature Tc at the center point on the end of the core soot preform in the range of 5 to 45° C.; and/or (2) maintaining the ratio R of the area in which the surface temperature at the end of the core soot preform is higher than the surface temperature Tc at the center point on the end of the core soot preform in the range of 5 to 30%.

### BACKGROUND OF THE INVENTION

1. Field of the Invention

The present invention relates to an improved VAD process that enables uniform deposition of glass microparticles, even when producing a large porous glass preform.

2. Description of the Related Art

The production of a porous preform used to make silicate optical fiber can be carried out by a variety of methods. One well-known example from among these methods is the VAD method. In the VAD method, glass microparticles synthesized by a core burner are deposited to the end of a vertically supported mandrel as the mandrel is rotated, and the core soot preform that will form the optical fiber core is developed into a rod form. At the same time, glass microparticles synthesized by the cladding burner are deposited on the periphery of the core soot preform to form the cladding soot preform that comprises part or all of the cladding. In this way, a porous preform is made. The thus-obtained porous preform is then subjected to high temperature heating, undergoing dehydration and consolidation to form a transparent glass preform. This glass transparent preform is then drawn to produce the optical fiber.

In order to synthesize glass microparticles in the core and cladding burners, raw material gases such as silicon tetrachloride (SiCl₄) and germanium tetrachloride (GeCl₄), fuel gases such as hydrogen, supporting gases such as oxygen to augment burning, and inert gases such as argon, are supplied. In addition, in order to provide the optical fiber with a refractive index profile, a different composition of raw material gases is supplied to the core and cladding burners respectively. Namely, a dopant such as GeO₂ is doped at a specific concentration to the core portion, thereby providing the optical fiber with a refractive index profile.

In addition, in order to apply a specific refractive index profile to an optical fiber, a dopant like GeO₂ is applied to the core, and further, the surface temperature of the core soot preform is appropriately controlled to add a specific amount of dopant. This is because, depending on the dopant employed, the doping efficiency, i.e., the dopant incorporated into the core soot preform, can vary greatly according to the surface temperature of the core soot preform.

Therefore, for example, radiation thermometers are placed around the core soot preform and the core soot preform surface temperature distribution is measured. Based on these measured values, heating conditions such as the amount of fuel gas supplied to the core burner and the relative positioning of the core burner and the core soot preform, and the surface temperature of the core soot preform is controlled, so that the dopant is incorporated at the desired concentration distribution.

In addition, to facilitate measurement, the temperature is generally measured by placing the radiation thermometers around the lateral direction of the core soot preform.

For example, it is disclosed that there is an appropriate core soot preform surface temperature range when doping GeO₂ in the VAD method, in The Transaction of the Institute of Electronics and Communication Engineers, Vol. J65-C, No. 4, p. 292-299, April, 1982.

However, there has been a trend in recent years toward increasing the dimensions of the porous preform so that optical fiber production costs can be reduced. On the other hand, as the dimensions of the porous preform increase, the outer diameter of the core soot preform increases. As a result, whereas previously the temperature distribution at the ends of the core soot preform had been roughly constant when depositing the glass microparticles, variations in temperature that are not negligible arise around the core soot preform ends due to the larger diameter of the core soot preform.

The areas at the core soot preform ends are the most center-positioned regions in the refractive index profile that forms the optical fiber. In order to obtain the desired characteristics, it is necessary to control the temperature of the surface where the core soot preform is deposited in this area especially. However, when the temperature variations in this area become large in the core soot preform, this temperature distribution cannot be suitably controlled, so that the concentration of the dopant is not uniform. As a result, there is increased variation in the optical fiber characteristics, so that an optical fiber with stable characteristics cannot be produced. When the temperature variation in this area becomes large, the adhesion and deposition of the glass microparticles becomes non-uniform along the radial direction, generating a rugged surface in the core soot preform (referred to as “rugged soot preform” in this specification). As a result, it is not possible to continue producing the porous preform.

### BRIEF SUMMARY OF THE INVENTION

The present invention was conceived in view of the above-described circumstances and has as its objective the provision of a method for producing a porous preform in which a dopant can be stably doped to the core soot preform and rugged soot preform can be prevented.

The aforementioned problems are resolved by a method for producing a porous preform in which the core soot preform is formed by depositing glass microparticles, synthesized by flame hydrolysis or thermal oxidation of raw material gases expelled from the core burner, onto the end of the mandrel, while at the same time forming the cladding soot preform by depositing glass microparticles, synthesized by flame hydrolysis or thermal oxidation of raw material gases expelled from the cladding burner, around the core soot preform; wherein the surface temperature distribution at the end of the core soot preform is measured and the heating conditions by the core burner are set so that the temperature Tc at the center point of the end of the core soot preform is in the range of 500 to 1000° C., and more preferably in the range of 600 to 950° C., and that the difference Tm−Tc between the maximum surface temperature Tm at the core soot preform end and the surface temperature Tc at the center of the core soot preform end is in the range of 5 to 45° C.

The aforementioned problems are also resolved by a method for producing a porous preform in which the core soot preform is formed by depositing glass microparticles, synthesized by flame hydrolysis or thermal oxidation of raw material gases expelled from the core burner, onto the end of the mandrel, while at the same time forming the cladding soot preform by depositing glass microparticles, synthesized by flame hydrolysis or thermal oxidation of raw material gases expelled from the cladding burner, around the core soot preform; in the area at said core soot preform end where the angle formed by a line extending vertically from the soot preform surface and a line extending in the normal line direction is 55° or less, the proportion R of the area in which the surface temperature is higher than the surface temperature Tc at the center point of said core soot preform end is maintained in the range of 5 to 30%.

In this type of porous preform production method, it is desirable to control the heating conditions in the core burner so that the surface temperature at the end of the core soot preform is in the above-described range.

### BRIEF DESCRIPTION OF THE DRAWINGS

FIG. 1 is a schematic structural view showing an example of the manufacturing device employed to execute the method of the present invention for producing a porous preform.

FIG. 2 is a cross-sectional diagram for explaining the radiating angle.

FIG. 3 is a view showing one example of the surface temperature distribution at the end of the core soot preform.

FIG. 4 is a partial schematic view showing an example of the manufacturing device employed to execute the method of the present invention for producing a porous preform as seen from below.

FIG. 5 is a lateral view for explaining the method for determining the end of the core soot preform.

FIG. 6 is a graph showing an example of the relationship between Tc and Δ variation.

FIG. 7 is a graph showing an example of the relationship between Tm−Tc and Δ variation.

FIG. 8 is a graph showing an example of the relationship between R and Δ variation.

### PREFERRED EMBODIMENTS OF THE INVENTION

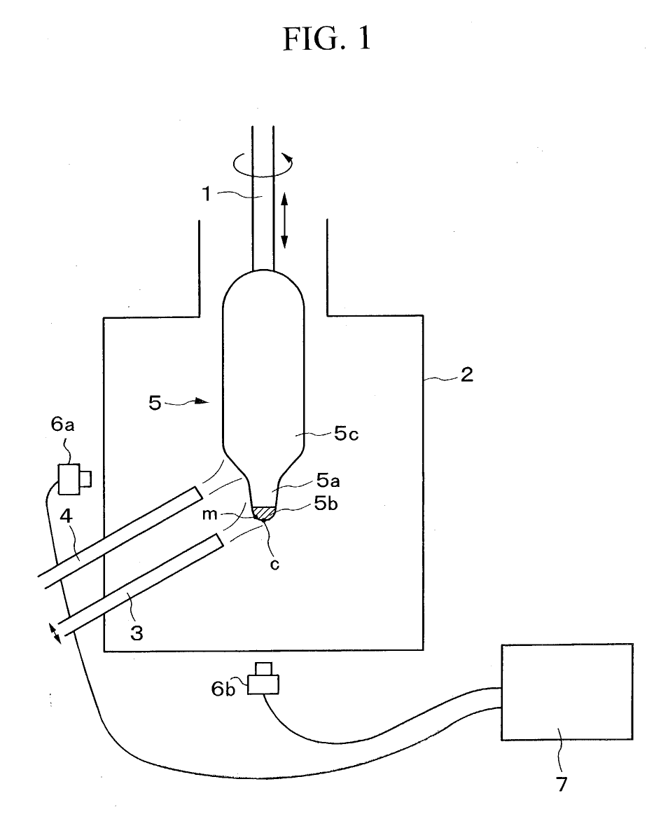

The present invention will now be explained in greater detail based on preferred embodiments thereof. FIG. 1 shows an example of a manufacturing device for executing the porous preform production method of the present invention.

In FIG. 1, reference numeral 1 indicates a mandrel. The Mandrel 1 hangs vertically inside a chamber 2, and can be rotated and moved up and down by a driving means (not shown in the figures).

A core burner 3 and a cladding burner 4 are disposed inside the chamber 2. Only one cladding burner 4 is shown in FIG. 1; however, it is acceptable to provide a plurality of these as well. The core burner 3 and the cladding burner 4 are designed to synthesize glass microparticles from fuel gases such as hydrogen and supporting gases like oxygen and material gases such as SiCl₄ and GeCl₄ that are supplied from a gas supply source (not shown in the figures).

The glass microparticles synthesized by the core burner 3 are deposited to the end of the mandrel 1 that is hanging vertically downward, forming a the core soot preform 5a. The glass microparticles that are synthesized by the cladding burner 4 are deposited around the outer periphery of the core soot preform 5a to form a cladding soot preform 5c. The soot preform 5 consisting of the core soot preform 5a and the cladding soot preform 5c develops in the axial direction to ultimately form the porous preform.

The flow of fuel and raw material gases supplied to the core burner 3 can be adjusted using a flow adjusting device (not shown in the figures). The core burner 3 can move in a horizontal or vertical direction through a moving means (not shown in the figures).

First and second radiation thermometers 6a and 6b are provided to the side of and directly below the core soot preform 5a, respectively. First and second radiation thermometers 6a and 6b are connected to an image processing data recording device 7. The heating conditions for the core burner 3 can be adjusted based on the surface temperature distribution at the end 5b and the side surface of the core soot preform 5a that is measured by the first and the second radiation thermometers 6a and 6b.

In these preferred embodiments, the surface temperature distribution at the end 5b of the core soot preform 5a is measured using the manufacturing device shown in FIG. 1, and the heating conditions that the core soot preform 5a is subjected to by the core burner 3 are determined based on these measured values.

The reason for providing the second radiation thermometer 6b vertically below the core soot preform 5a is as follows.

As discussed above, as the outer diameter of the core soot preform 5a increases, temperature variations that cannot be ignored begin to occur at the surface of the core soot preform end 5b. However, for the reasons below, it is not possible to ascertain this temperature variation at the core soot preform end 5b using just the first radiation thermometer 6a.

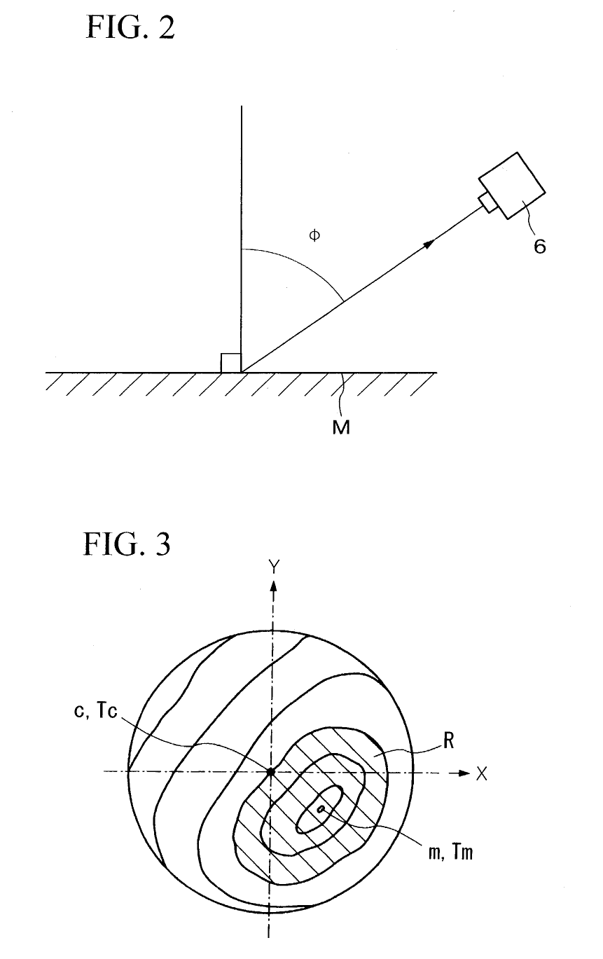

It is known that in general, the emissivity at the surface of an object depends on the direction of radiation. In other words, as shown in FIG. 2, for infrared radiation radiated from the surface of an object M, when the radiating angle φ is defined as the angle formed by the direction of the radiation and a line normal to the surface of the object M, then emissivity is roughly constant when φ is 55° or less in the case of a porous glass preform. However, when the radiating angle φ exceeds 55°, emissivity decreases remarkably, so that it is not possible to obtain an accurate measurement of temperature at radiation thermometer 6 (6a and 6b).

Accordingly, in the case where the surface temperature at the end 5b of the core soot preform 5a is measured by placing the first radiation thermometer 6a only at the side of the core soot preform 5a as in the conventional art, the measurement of the surface temperature distribution at the end 5b of the core soot preform 5a becomes less precise since the radiating angle φ is large with respect to the first radiation thermometer 6a. As a result, heating conditions are not accurately controlled. To solve this problem, the second radiation thermometer 6b is provided vertically below soot preform 5.

In order to determine the extent to which the positions of first and second radiation thermometers 6a and 6b affect the measurement of the surface temperature at the end 5b of the core soot preform 5a, the present inventors measured the surface temperature distribution at the end 5b of the core soot preform 5a using the first and the second radiation thermometers 6a and 6b in the manufacturing device shown in FIG. 1. As a result, an approximately 200° C. or greater difference was discovered between the measured value at the first radiation thermometer 6a positioned at the side of the core soot preform 5a and second radiation thermometer 6b positioned vertically below the core soot preform 5a.

Accordingly, it was considered that the surface temperature distribution at the end 5b of the core soot preform 5a could be accurately measured by placing the second radiation thermometer 6b vertically below the core soot preform 5a.

An example of the method for adjusting the heating conditions by the core burner 3 based on the measured values of the surface temperature distribution will now be explained.

FIG. 3 is an example of the surface temperature distribution at the end 5b of the core soot preform 5a that was measured using second radiation thermometer 6b. In this example, the center point c on the end 5b of the core soot preform 5a shown in FIG. 1 corresponds to the center of the surface temperature distribution. In the example shown in FIG. 2, the temperature at the position m where the temperature increases, is denoted as Tm. As the distance from this point increases, the surface temperature drops, so that an isothermal line is described that is centered on m.

When adjusting the heating conditions by the core burner 3 based on the surface temperature distribution at the end 5b of the core soot preform 5a, a method may be proposed which satisfies conditions such as:

(1) the surface temperature Tc at the center point c on the end 5b of the core soot preform 5a is in the range of 500 to 1000° C., and preferably in the range of 600 to 950° C.; and the difference Tm−Tc between the maximum surface temperature Tm at the end 5b of the core soot preform 5a and the surface temperature Tc at the center point c on the end 5b of the core soot preform 5a is in the range of 5 to 45° C.; and

(2) the ratio R of the area in which the surface temperature at the end 5b of the core soot preform 5a is higher than the surface temperature Tc at the center point c on the end 5b of the core soot preform 5a is in the range of 5 to 30%.

By using any of these conditions, a dopant such as GeO₂ can be stably doped. In particular, it is preferable to adjust the heating conditions so as to satisfy all these conditions.

When these conditions are not satisfied, the dopant cannot be stably doped. Accordingly, this is not desirable as there is a large amount of variation along the longitudinal direction of the refractive index profile of the porous preform, and rugged soot preform occurs.

As described above, the amount of a dopant such as GeO₂ that is doped will vary according to the surface temperature of the core soot preform 5a in the doped area. In particular, when the surface temperature exceeds 1000° C., the vapor pressure of the GeO₂ increases, so that the amount doped to the core soot preform 5a becomes extremely unstable. Further, the bulk density of the core soot preform 5a increases, so that the subsequent dehydrating process tends to be insufficient.

In the area at the end 5b of the core soot preform 5a, the center c of the end 5b of the core soot preform 5a is the same as the center of a rotation of the mandrel 1. When the center c of the core soot preform end and position m, where the temperature is maximal, coincide, positional variations arising from rotation do not occur. Thus, local concentration of the dopant can readily increase. Under these circumstances, the concentration of the dopant can vary dramatically in the area around the center of the core soot preform end 5b. For this reason, even slight variations in production conditions caused by a disturbance of some sort can result in rapid changes in the concentration of the dopant.

On the other hand, the amount of glass microparticles deposited on the core soot preform 5a also depends on the surface temperature of the core soot preform 5a. When the temperature is high, the space surrounding the glass microparticles is small, while when the temperature is low, the space around the glass microparticles is larger. In other words, the bulk density and the volume of the glass microparticles deposited varies depending on temperature variations. For this reason, when the temperature gradient becomes too large in the radial direction of rotation at the end 5b of the core soot preform 5a, the volume of adhered glass microparticles becomes non-uniform in the radial direction, resulting in rugged soot preform.

Examples of the heating conditions in the core burner 3 that are applied to the core soot preform 5a include the flow volume of fuel gases such as hydrogen and supporting gases such as oxygen, and the relative positioning of the core burner 3 and the end 5b of the core soot preform 5a.

If heating conditions such as these are preset using test runs prior to producing the actual product, then these conditions can be adjusted prior to manufacture of the product so that the porous preform can be produced with these conditions held constant during production. As a result, these conditions do not have to be controlled or varied during production, so that production is facilitated.

It is also acceptable to employ a suitable control device to control the heating conditions by suitably varying them during operation.

In addition, it is also acceptable to first produce a porous preform by holding the heating conditions constant, and then, when the surface temperature conditions at the core soot preform 5a seem likely to exceed the above-prescribed limits, to then begin controlling the heating conditions. That is, under these circumstances, the heating conditions can be suitably varied so as to maintain the above-defined range, so that glass microparticles can be continuously deposited.

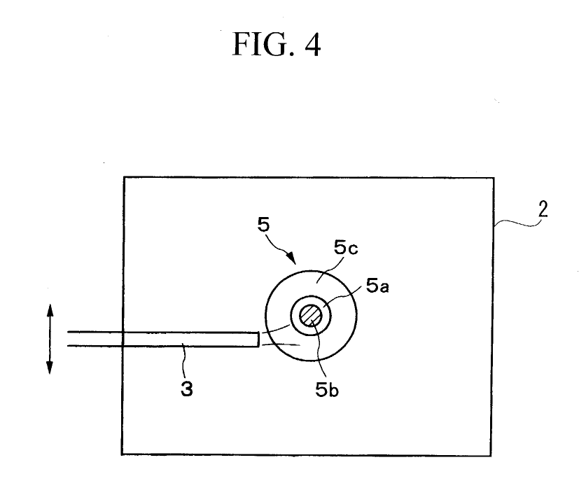

The following method is available as a method for adjusting the relative positioning of the end 5b of the core soot preform 5a and the core burner 4. For example, FIG. 4 shows the manufacturing device in FIG. 1 as seen from below. As shown in FIG. 4, the heating conditions at the core burner 3 can be varied by moving the core burner 3 in the horizontal direction. In addition, by raising or lowering the mandrel 1, the heating conditions at the core burner 3 can be adjusted.

In addition, the core burner 3 can be moved perpendicularly up or down, or can be moved toward or away from the core soot preform 5a.

The wavelength measured at the first and the second radiation thermometers 6a and 6b will depend on the type of radiation thermometer employed. Accordingly, there are no particular restrictions applied to the wavelength. Provided that the surface temperature distribution at the core soot preform 5a can be measured with good accuracy, then the measurement can be conducted using the wavelengths employed in the usual radiation thermometer. For example, a 3.0 to 5.3 μm band may be adopted in order to eliminate absorption by the moisture vapor in the air or flame emitted from the core burner 3.

In this embodiment, the end 5b of the core soot preform 5a is the area on the core soot preform 5a in which the radiation angel φ with respect to the second radiation thermometer 6b positioned perpendicularly below the core soot preform 5a is 55° or less. As a result of this design, the surface temperature distribution at the end 5b of the core soot preform 5a can be measured by the second radiation thermometer 6b, thereby further simplifying the device design.

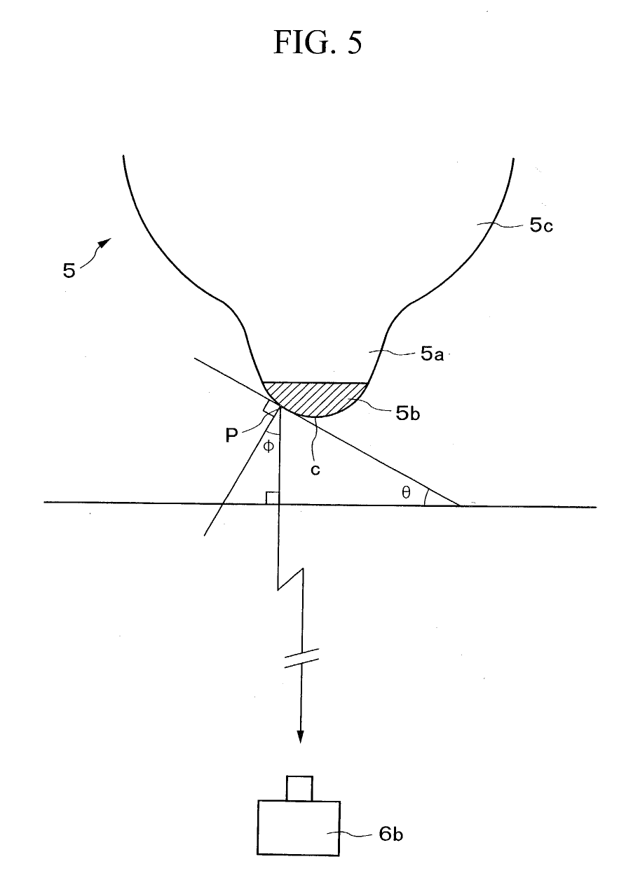

In this case, as shown in FIG. 5, since second radiation thermometer 6b is located perpendicularly below the core soot preform 5a, radiating angle φ at an optional point P on the surface of the core soot preform 5a is equal to angle θ formed between the tangential and horizontal planes at point P. Accordingly, when determining the end 5b of the core soot preform 5a, the contour of the end 5b of the core soot preform 5a is measured using a CCD camera from the side of the core soot preform 5a, and the end 5b can be determined using image processing of the measured contour.

As in the case of the conventional art, a porous preform formed according to this embodiment can be formed into an optical fiber by drawing after heating and transparent-vitrifying.

Next, the present invention will be explained using examples. A porous preform was produced using the manufacturing device shown in FIG. 1.

The wavelength measured by the first and the second radiation thermometers 6a and 6b, was in the range of 3.0 to 5.3 μm. A multi-pipe burner having supply ports for hydrogen, oxygen and argon provided in stratification around the supply ports for the raw material gases were employed as the core burner 3. The flow rates of oxygen gas, SiCl₄, GeCl₄, and argon were 21 liters/minute, 1.8 liters/minute, 0.12 liters/minute, and 8.2 liters/minute, respectively.

The flow rate of hydrogen gas supplied to the core burner 3 was varied in the range of 19 to 37 liters/minute. Heating conditions of the soot preform end 5b were varied by moving the core burner 3 and the core soot preform 5a relative to one another.

By varying the heating conditions of the core burner 3, the relative position coordinates of point m with respect to point c in the surface temperature distribution shown in FIG. 3 was varied in the range of 0 to 1.8 mm for the X coordinate and −2.2 to −0.2 mm for the Y coordinate.

Glass microparticles were deposited under these respective conditions, to produce a plurality of porous preforms with a diameter of 200 mm and a length of 700 mm. Then, the porous preforms were heated to form the transparent glass preforms. In order to investigate the variation along the longitudinal direction of the specific refractive index difference Δ for these transparent glass preforms, 12 measurement points were set at equal intervals along the longitudinal direction using a preform analyzer, the specific refractive index difference Δ was measured and the variations in these measurements were calculated.

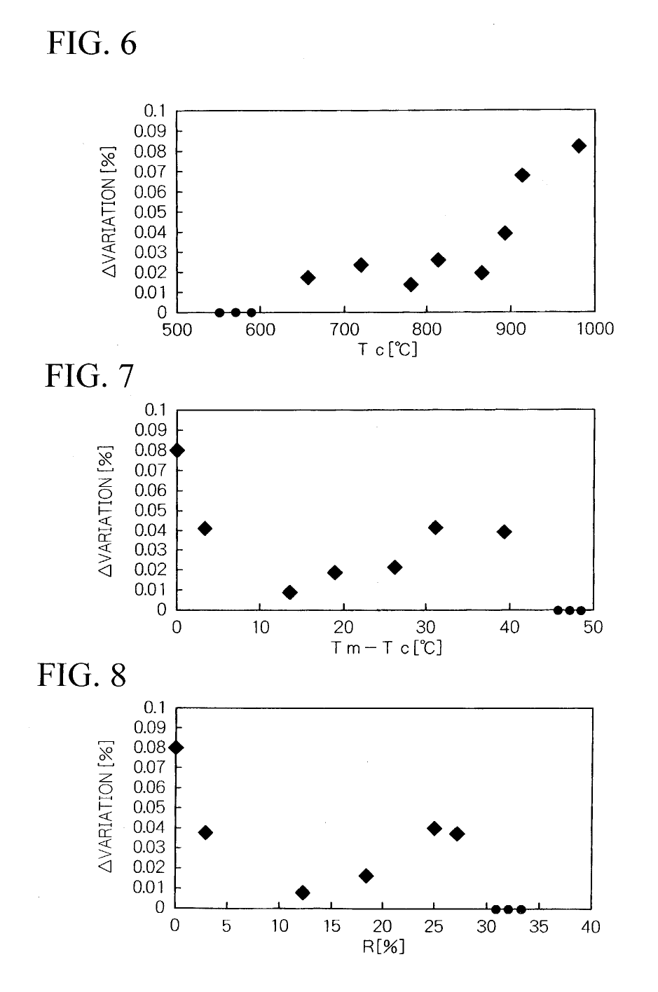

FIG. 6 is a graph showing an example of the relationship between Δ variation and Tc when Tc is varied.

FIG. 7 is a graph showing an example of the relationship between Tm−Tc and Δ variation when Tm−Tc is varied.

FIG. 8 is a graph showing an example of the relationship between R and A variation when R is varied.

In FIGS. 6 to 8, the mark [♦] indicates cases where a porous preform could be produced in which no rugged soot preform occurred, and indicates the value of the A variation shown on the vertical axis. The mark [●] indicates cases where rugged soot preform occurred. When rugged soot preform occurred, production of the porous preform was halted, and the Δ variation of the transparent glass preform was not measured.

As is clear from these results, when 500° C.≦Tc≦1000° C., 5° C.≦Tm−Tc≦45° C., and 5%≦R≦30%, Δ variation could be held to a small value of 0.05% or less and it was possible to prevent rugged soot preform from occurring.

In addition, glass microparticle deposition was carried out from the beginning after setting the heating conditions at the core soot preform end so that 500° C.≦Tc≦1000° C., 5° C.≦Tm−Tc≦45° C., and 5%≦R≦30%, to form a porous preform having a diameter of 200 mm and a length of 700 mm. As a result, a porous preform could be produced in which the Δ variation in the specific refractive index difference over the entire length was small, and the occurrence of rugged soot preform could be prevented.

Of course when there occurs a concern that the values of Tc, Tm−Tc, and R during deposition of the glass microparticals may have deviated outside the ranges of 500° C.≦Tc≦1000° C., 5° C.≦Tm−Tc≦45° C., and 5%≦R≦30%, it is acceptable to continue to deposit the glass microparticles by controlling and suitably varying the heating conditions at the core soot preform end so as to maintain the above-prescribed range. It goes without saying that in this case as well, excellent results can be obtained.

As explained above, as a result of the production method of the present invention for a porous preform, it is possible to control variations in characteristics along the length of the fiber minimum, so that a superior optical fiber can be produced. In addition, rugged soot preform can be prevented and productivity can be improved.

What is claimed:

1. A production method for a porous preform in which a core soot preform is formed by depositing glass microparticles, synthesized by flame hydrolysis or thermal oxidation of raw material gases expelled from a core burner, onto the end of a mandrel, while at the same time forming a cladding soot preform by depositing glass microparticles, synthesized by flame hydrolysis or thermal oxidation of raw material gases expelled from a cladding burner, around said core soot preform; wherein,
the surface temperature Tc at the center point of the end of said core soot preform is in the range of 500 to 1000° C., and
the difference Tm−Tc between the maximum the surface temperature Tm at said core soot preform end and the surface temperature Tc at the center of said core soot preform end is in the range of 5 to 45° C.

2. A production method for a porous preform in which a core soot preform is formed by depositing glass microparticles, synthesized by flame hydrolysis or thermal oxidation of raw material gases expelled from a core burner, onto the end of a mandrel, while at the same time forming a cladding soot preform by depositing glass microparticles, synthesized by flame hydrolysis or thermal oxidation of raw material gases expelled from a cladding burner, around said core soot preform; wherein,
in the area at said core soot preform end where the angle formed by a line extending vertically from the soot preform surface and a line extending in the normal line direction is 55° or less, the proportion R of the area in which the surface temperature is higher than the surface temperature Tc at the center point of said core soot preform end is maintained in the range of 5 to 30%.

3. A production method for a porous preform according to claim 1 or 2, wherein heating conditions of the soot preform end by the core burner are controlled.
